(19) United States
(12) Patent Application Publication
(10) Pub. No.: US 2014/0095328 A1
(43) Pub. Date: Apr. 3, 2014

(54) INTERACTIVE REVEAL AD UNIT

(71) Applicant: YAHOO! INC., Sunnyvale, CA (US)

(72) Inventors: Shaun Forouzandeh, Los Angeles, CA (US); Guy Schackman, Santa Monica, CA (US); Agnes Liu, Walnut, CA (US); Chialing Hsu Sarva, New York, NY (US); Bonnie Pan, San Francisco, CA (US)

(73) Assignee: YAHOO! INC., Sunnyvale, CA (US)

(21) Appl. No.: 13/792,569

(22) Filed: Mar. 11, 2013

Related U.S. Application Data
(60) Provisional application No. 61/707,812, filed on Sep. 28, 2012.

(51) Int. Cl. G06Q 30/02

(52) U.S. Cl. CPC G06Q 30/0277
USPC 705/14.73

(57) ABSTRACT

An interactive reveal advertising unit is presented in a webpage. The motion and animation of the advertising unit's creative is tied to the user interaction with the device displaying the webpage, the web page or the advertising unit itself, so that the creative responds directly to the user interaction. The overall layout of the creative elements in the unit is changed based on various factors. The advertising unit also expands to reveal an expanded canvas that displays additional media.

### CROSS REFERENCES TO RELATED APPLICATIONS

This application is a non-provisional of and claims priority to U.S. provisional patent application No. 61/707,812 filed on Sep. 28, 2012 and entitled “Interactive reveal ad unit”, the entirety of which is incorporated herein by reference.

The present disclosure relates to an interactive advertising unit that responds to user interactions.

### BACKGROUND

Online advertising has become a popular medium among marketers to promote their products on the Internet. Advertisements are included on web pages based on content of the web pages or popularity of the web page. Such advertisements generate revenue for content providers while also providing information to users. The advertisements can include static images or animated content.

### SUMMARY

Various embodiments disclosed herein provide for an interactive reveal advertising unit or overlay that responds to a user interaction with a webpage comprising the advertising unit. The advertising unit enables advertisers to forge a deeper connection with users through an interactive, addictive and playful experience. It increases engagement over standard, static ad units that do not update the creative message in the advertising unit based on received input or implicit or explicit detected user actions, for example through interaction with a page in which the ad unit is displayed or by interaction or movement of the computing device on which the ad unit is displayed.

A method of providing content executable by a processor is disclosed in an embodiment. The method comprises, displaying, on a display of a computing device, a webpage comprising an advertising unit. The method further comprises, receiving, at the device, information representing user interaction with one of the webpage, the advertising unit or the device. In an embodiment, the device effectuates a scroll of the webpage based on the user interaction information. The method further involves effecting gradually, by the device, visible changes to content/creative and size of the advertising unit based on the user interaction such that an amount of the content displayed and the size of the advertising unit depends on a position of the advertising unit relative to the webpage. The method also comprises, determining if the advertising unit has attained a maximum possible size and displaying, by the device, further interactive content in the advertising unit upon the determination that the advertising unit has attained the maximum possible size. In an embodiment, the visible changes comprise increasing the size of the advertising unit and the amount of the content as the scroll occurs along a first direction so that additional content is displayed gradually in the advertising unit based on the size and on the position of the advertising unit relative to the webpage. In an embodiment, the visible changes comprise decreasing the size of the advertising unit and removing the additional content when the scroll occurs along a second direction that is opposite to the first direction. In an embodiment, the content in the advertising unit is re-arranged upon the user interaction information indicating a change in an orientation of the computing device in the three-dimensional space. In an embodiment, the content in the advertising unit is re-arranged based upon a change in the display of the computing device. In an embodiment, the interactive content is displayed upon receiving further user input. In an embodiment, the interactive content is video content and the further user input comprises a click on a video player displayed in the advertising unit.

A computing device comprising a processor and a storage medium for tangibly storing thereon program logic for execution by the processor is disclosed in an embodiment. The program logic comprises, display logic for displaying a webpage comprising an advertising unit on a display of the computing device, user interaction receiving logic for receiving information representing user interaction with one of the webpage, the advertising unit or the device and effecting logic, for effecting gradual visible changes to content and size of the advertising unit based on the user interaction such that an amount of the content displayed and the size of the advertising unit depends on a position of the advertising unit relative to the webpage. In an embodiment, the computing device comprises size determining logic for determining if the advertising unit has attained a maximum possible size and display logic for displaying further interactive content in the advertising unit upon the determination that the advertising unit has attained the maximum possible size. In an embodiment, the program logic further comprises scrolling logic that scrolls the webpage based on the user interaction information. In an embodiment, the effecting logic further comprises, size increasing logic that increases the size of the advertising unit as the scroll occurs along a first direction. In an embodiment, the effecting logic further comprises, size decreasing logic that decreases the size of the advertising unit as the scroll occurs along a second direction that is opposite to the first direction. In an embodiment, the effecting logic further comprises additional content display logic such that the amount of additional content displayed in the advertising unit is increased when the advertising unit moves in the first direction and the amount of additional content displayed in the advertising unit is decreased when the advertising unit moves in the second direction. In an embodiment, the programming logic comprises content rearranging logic that rearranges the content or the creative in the advertising unit upon the user interaction information indicating a change in an orientation of the computing device in the three-dimensional space.

A computer readable storage medium, comprising instructions, which when executed by a processor cause the processor to display, on a display of a computing device, a webpage comprising an advertising unit, receive, at the device, information representing user interaction with one of the webpage, the advertising unit or the device and effect visible changes to content and size of the advertising unit gradually based on the user interaction such that an amount of the content displayed and the size of the advertising unit depends on a position of the advertising unit relative to the webpage. In addition, the instructions further cause the processor to determine if the advertising unit has attained a maximum possible size and display further interactive content in the advertising unit upon the determination that the advertising unit has attained the maximum possible size. The computer readable medium further comprises instructions for effectuating a scroll of the webpage based on the user interaction information. In an embodiment, the instructions for effecting visible changes further comprise instructions for increasing the size of the advertising unit and gradually displaying additional content as the scroll occurs along a first direction. In an embodiment, the instructions for effecting visible changes further comprise instructions for decreasing the size of the advertising unit and removing the additional content when the scroll occurs along a second direction that is opposite to the first direction.

### BRIEF DESCRIPTION OF THE DRAWINGS

In the drawing figures, which are not to scale, and where like reference numerals indicate like elements throughout the several views:

FIG. 1 shows a flow chart illustrating an embodiment of a method executable by a processor for producing an interactive advertising unit in accordance with an embodiment of the present disclosure;

FIG. 2 is a flowchart illustrating an embodiment of a method executable by a processor for producing an interactive advertising unit in accordance with an embodiment of the present disclosure;

FIG. 3 shows a schematic illustration of a webpage including the advertising unit in accordance with an embodiment of the present disclosure;

FIG. 4 shows a schematic illustration of the webpage including the advertising unit at a higher position in accordance with an embodiment of the present disclosure;

FIG. 5 shows a schematic illustration of the webpage including the advertising unit at a higher position when compared to FIG. 4 in accordance with an embodiment of the present disclosure;

FIG. 6 is another illustration showing the advertising unit higher up in the webpage and showing additional content in accordance with an embodiment of the present disclosure;

FIG. 7 is another illustration showing the changes occurring in the advertising unit as a result of its displacement from the initial position in accordance with an embodiment of the present disclosure;

FIG. 8 is another illustration showing the changes occurring in the advertising unit as a result of its gradual displacement from the initial position at the bottom of the webpage in accordance with an embodiment of the present disclosure;

FIG. 9 is a schematic figure wherein the advertising unit plays a video associated with the advertiser upon the user clicking the play button in accordance with an embodiment of the present disclosure;

FIG. 10 is a schematic diagram showing an interactive reveal ad unit responding to an input in accordance with an embodiment of the present disclosure;

FIG. 11 is a schematic diagram illustrating an embodiment wherein the advertising unit or the overlay is automatically adjusted to suit the width and resolution of an output device in accordance with an embodiment of the present disclosure;

FIG. 12 is a block diagram depicting certain modules within an overlay or an ad unit display engine in accordance with an embodiment of the present disclosure;

FIG. 13 shows an illustrative embodiment of a communication system comprising a plurality of computing devices configured to implement various aspects of the interactive ad unit in accordance with an embodiment of the present disclosure;

FIG. 14 shows internal architecture of a computing device in accordance with an embodiment of the present disclosure;

FIG. 15 is a schematic diagram illustrating a client device implementation of a computing device in accordance with an embodiment of the present disclosure.

### DESCRIPTION OF EMBODIMENTS

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein, example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

In the accompanying drawings, some features may be exaggerated to show details of particular components (and any size, material and similar details shown in the figures are intended to be illustrative and not restrictive). Therefore, specific structural and functional details disclosed herein are not to be interpreted as limiting, but merely as a representative basis for teaching one skilled in the art to variously employ the disclosed embodiments.

The claimed subject matter is described below with reference to block diagrams and operational illustrations of methods and devices to select and present media related to a specific topic. It is understood that each block of the block diagrams or operational illustrations, and combinations of blocks in the block diagrams or operational illustrations, can be implemented by means of analog or digital hardware and computer program instructions. These computer program instructions or logic can be provided to a processor of a general purpose computer, special purpose computer, ASIC, or other programmable data processing apparatus, such that the instructions, which execute via the processor of the computer or other programmable data processing apparatus, implements the functions/acts specified in the block diagrams or operational block or blocks.

In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved. Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and applications software which support the services provided by the server.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), or other forms of computer or machine readable media, for example. A network may include the Internet, one or more local area networks (LANs), one or more wide area networks (WANs), wire-line type connections, wireless type connections, cellular or any combination thereof. Likewise, sub-networks, which may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs.

A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices may be remotely coupled to a network, such as via a telephone line or link, for example.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like. Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

Throughout the specification and claims, terms may have nuanced meanings suggested or implied in context beyond an explicitly stated meaning Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part. In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

With the advent of the Internet, an industry has arisen focused on serving advertisements (ads) on web pages to users. An ad is typically an item of computer code that is pulled from an ad server and incorporated into the desired web page. Generally the entity serving the ads receives the content from advertisers or agencies and must incorporate the content into the ad code. While some advertisements may garner users' attention, users generally tend to ignore ads that are anchored in fixed positions on pages. In order to attract and hold user' attention, ad makers attempt to create interactive ads which incorporate features such as flashing images/text, resizable windows or animations. While such features may attract users in some circumstances, other instances exist where users may find such interactive features intrusive.

Various embodiments disclosed herein enable creating compelling ads that adjust the level of interactivity based on user input. The advertisements in accordance with the various embodiments are more responsive to a user's moods and hence can attract and retain users' attention without being overtly intrusive. In an embodiment, the creative in the advertising unit can respond directly to the users' scrolling activity. In an embodiment, the layout of the creative elements in the advertising unit changes based on the position of the unit on the page. For example, the advertising unit can have a simple brand message when at the bottom of a webpage, and gradually reveal a more complex message as the user scrolls the unit to the top of the page. The advertising unit can expand on a user click to reveal an expanded canvas to display further interactive media such as photo galleries, video or other content in accordance with an embodiment. In an embodiment, the advertising unit also responds to user input such as resizing or re-orienting a display device as will be detailed further infra. Thus, the ads in accordance with embodiments disclosed are configured to subtly attract users' attention initially and gradually gain prominence on a display as users express greater interest. This is in contrast to existing ads that are either ignored or are so intrusive that they can annoy users.

The interactive reveal ad unit disclosed herein enables advertisers to forge a deeper connection with users through an interactive, addictive and playful experience. Thus, an advertising unit in accordance with different embodiments disclosed herein can increase engagement over standard, static ad units or mere size- or shape-changing ad units that change when merely clicked or moused-over.

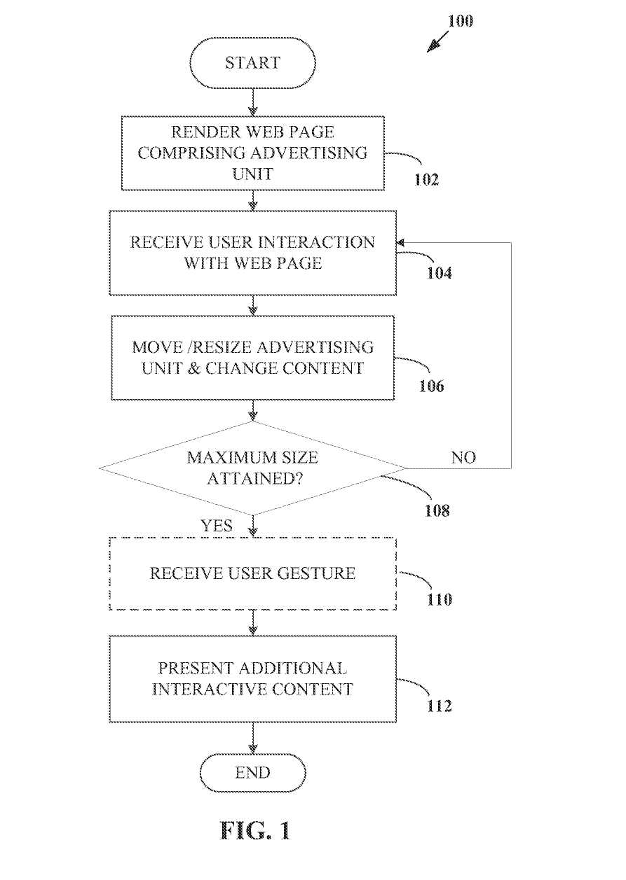

Turning now to the figures, FIG. 1 shows a flow chart illustrating an embodiment of a method executable by a processor for producing an interactive advertising unit. The method begins at 102 wherein a web page is rendered via a browser application or in an ‘app’ by a client/user device such as a desktop or a laptop computer or a mobile communication device such as a smart phone or a tablet. In addition to other content, the instructions cause the client/user device to display an advertising unit or an overlay showing a sponsor messages at a predetermined position on the webpage. By the way of illustration and not limitation, advertiser related content included in the advertising unit can comprise static or animated images, a video, slideshow, a camera feed, audio content or combinations thereof. In an embodiment, the advertising unit can be embedded within the requested web page or be an overlay or “transparency” reactive to the web page or computing device that the ad unit is displayed on. In an embodiment, the advertising unit can be a stand-alone module or a plug-in. At 104, user interaction with the web page is received, such as a page scroll, a finger swipe or slide, or a tilting of a tablet or smart phone with an on-board position sensor. For example, as the user scrolls/swipes up or down/tilts the webpage, such actions are detected. At 106, the advertising unit is moved from an initial position within the web page based on the user's interaction with the webpage. In addition, based on the position of the advertising unit in the webpage, the content and size of the advertising unit can vary. For example, the advertising unit can be initially placed at the bottom of the web page so that it does not substantially intrude into the users' view. As the user scrolls down the page thereby expressing interest in the web page content, the advertising unit can be gradually moved up the web page towards a more prominent position within the display of the user/client device. Conversely, the advertising unit can be placed at the top of the webpage in a non-intrusive manner and as the user scrolls down the webpage the advertising unit can gradually move down to a more prominent position within the webpage. In addition, the size of the advertising unit can be gradually increased and its content can be varied as it moves with the webpage to reach a most prominent position, for example, the center of the webpage. For example, as the size of the advertising unit gradually increases, changes such as gradually including additional images, text or other content not initially displayed, increasing the size of the content, reformatting or animating existing content, can be incorporated with the corresponding increase in the size. This changing position and/or content as the user changes page orientation is intended to act as a “teaser” to engage the user into further and deeper engagement with the ad unit as more content is revealed. At 108, it is determined if the advertising unit has attained its maximum size or optimal page or device position. In an embodiment, the advertising unit can attain its maximum size simultaneously as it attains the most prominent position within the user/client device display, for example, the center of the webpage or the user/client device display. If at 108, it is determined that the advertising unit has not yet attained its maximum size, the method returns to step 104 wherein the user interaction with the web page continues to be received and the advertising unit is re-positioned accordingly as shown at 106. If at 108, it is determined that the advertising unit has attained its maximum size, the method moves to step 110 wherein user interaction with the advertising unit is received. In an embodiment, a user gesture such as one or more of a click, scroll, tap or a swipe across the advertising unit is detected at 110. Based on the user gesture received at 110, additional interactive content can be retrieved and presented in the advertising unit at 112. For example, additional interactive content such as a video, an audio clip or a slide show can be presented. It can be appreciated that receiving the user gesture as shown at 110 can be optional and that the additional content can be presented at 112 automatically upon the advertising unit attaining the maximum size as shown at 108 and without any gesture/input from the user in accordance with one embodiment.

In one embodiment the advertising unit is also enabled to respond to the changes in the available display area. Generally when a webpage is presented to a user and the user resizes a browser window or re-orients a mobile device displaying the webpage, a part of the display is cut off or obscured from the view. In other instances, although a complete display is provided upon resizing the window, the optimum magnification of content is not achieved. For example, based on the resizing, the content magnification can be too small so that a user is unable to see the content clearly. In order to show the content of the entire advertising unit to the user at an optimum magnification at any given time, one embodiment is directed towards rearranging content in the creative presented within the advertising unit when a display size associated with the advertising unit is changed. For example, if the user resizes the window including the advertising unit or if the user re-orients a device displaying the advertising unit, the content in the advertising unit can be re-arranged in accordance with the user's actions so that the users can obtain a complete display regardless of the initial size or the initial orientation of the display. In an embodiment, the advertising unit can comprise a button that facilitates the user to close the advertising unit so that the user can continue to browse the webpage without interruptions.

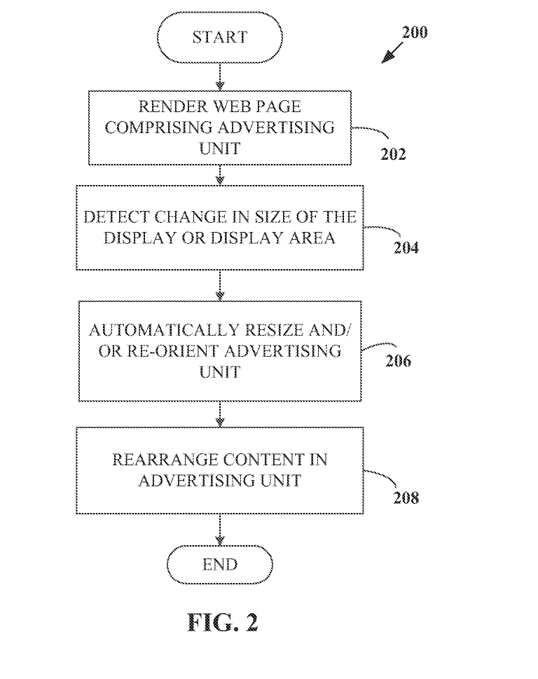

FIG. 2 is a flowchart 200 illustrating an embodiment of a method executable by a processor included, for example, on a user device, for producing an interactive advertising unit. The method begins at 202 with a webpage including the advertising unit or an overlay being rendered. At 204, a change in the size of the display or change in the available display area is detected. As discussed herein, a change in the size of the display can be detected when a browser or application window including the advertising unit is resized or when an orientation of a device (such as by way of non-limiting example a pad or tablet or smartphone or gaming unit) displaying the webpage with the advertising unit is changed, for example, from landscape or a portrait orientation or vice versa. At 206, the advertising unit is automatically resized and/or re-oriented based on the change in one or more of the size and orientation detected at 204. At 208 the content in the advertising unit is rearranged. In a further embodiment the magnification of the content in the advertising unit can also be adjusted to provide a complete and clear display to the user so that all the content in the advertising unit is displayed at the optimum magnification. In an embodiment, the optimum magnification can be 100%.

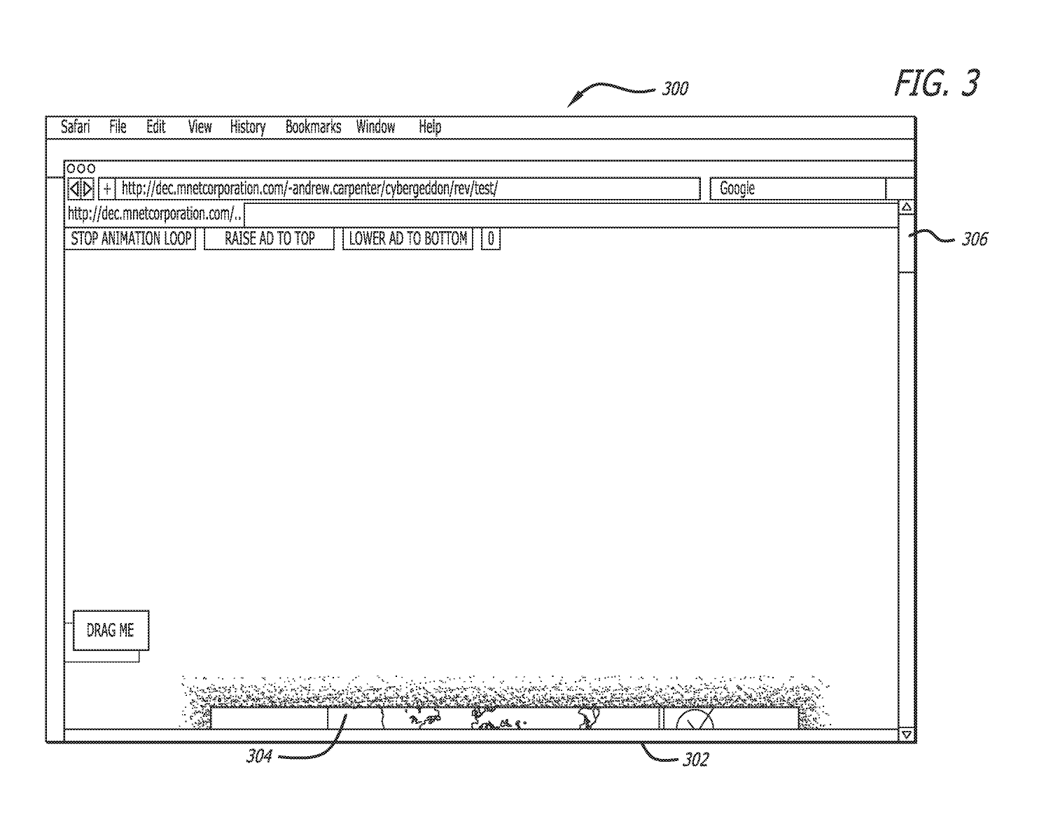

FIG. 3 shows a schematic illustration 300 of a webpage 302 including the advertising unit 304 at the bottom of the webpage. In an embodiment, this can be the initial position of the advertising unit 304 when the user navigates to the webpage 302 and it is initially loaded into the browser/app on the user device. Accordingly, the scrollbar 306 is initially positioned at the top of the webpage. In an embodiment, a ‘drag me’ button can be provided as shown in FIG. 3 to draw the user's attention to the advertising unit 304 and to facilitate the user to pull the advertising unit 304 up the webpage 302.

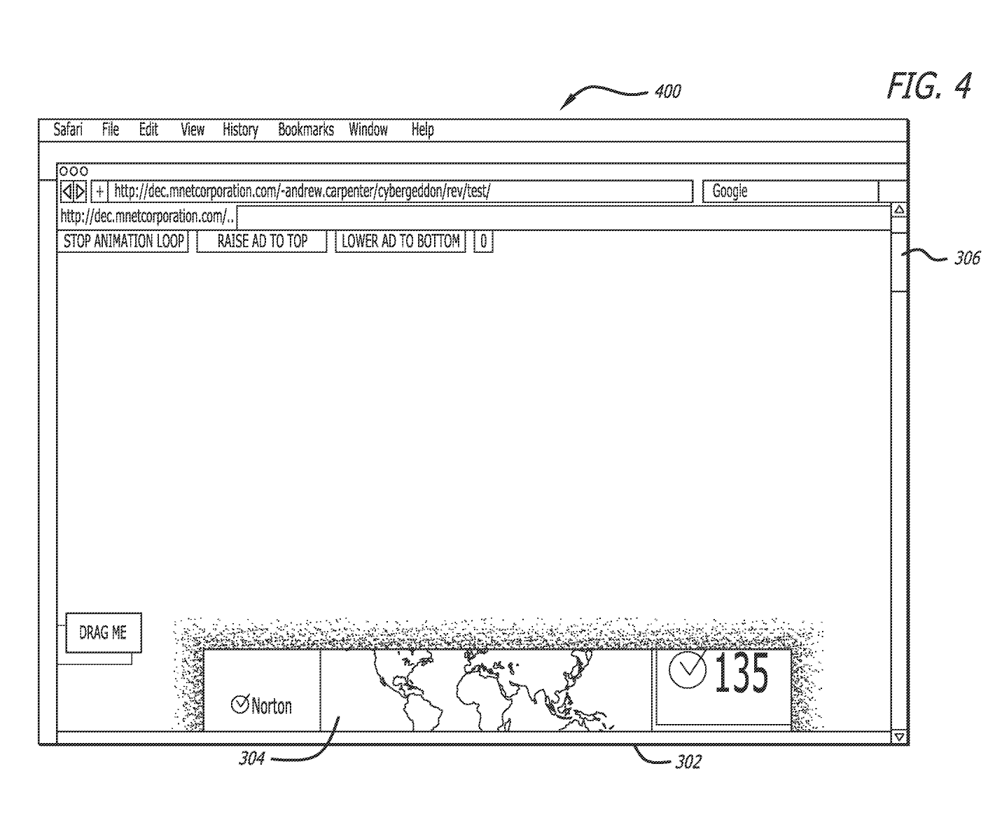

FIG. 4 shows a schematic illustration 400 of the webpage 302 including the advertising unit 304 at a higher position when compared to FIG. 3. In an embodiment, the position of the advertising unit 304 is raised as the user scrolls down the webpage 302 as indicated by the position of the scrollbar 306.

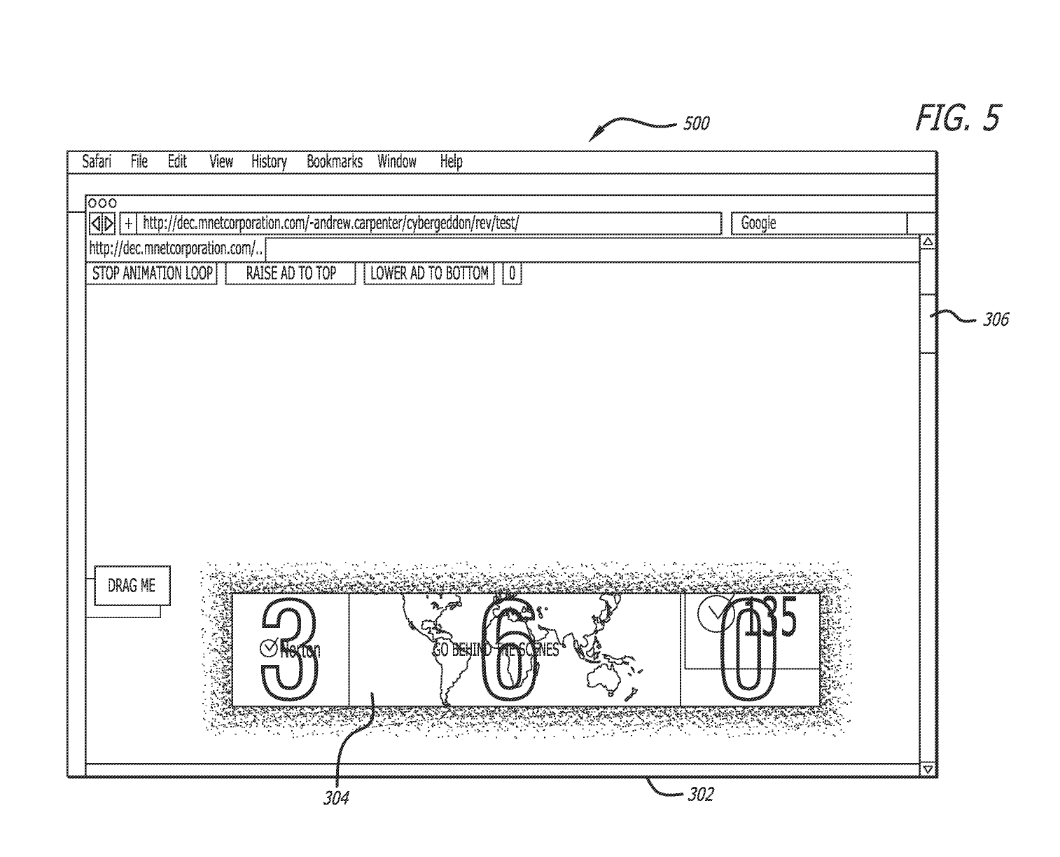

FIG. 5 shows a schematic illustration 500 of the webpage 302 including the advertising unit 304 at a higher position as the user scrolls lower when compared to FIG. 4 as indicated by the position of the scroll bar 306. In addition to showing the elevation of the advertising unit 304 with respect to FIG. 4, it can also be seen in FIG. 5 that additional content is presented in the advertising unit 304. For example, the characters ‘360’ which were not visible in FIG. 4 are now seen in FIG. 5. Thus, scrolling by the user not only gradually changes the position of the advertising unit 304, but the content in the advertising unit 304 can also be changed due to the gradual change in the position of the advertising unit.

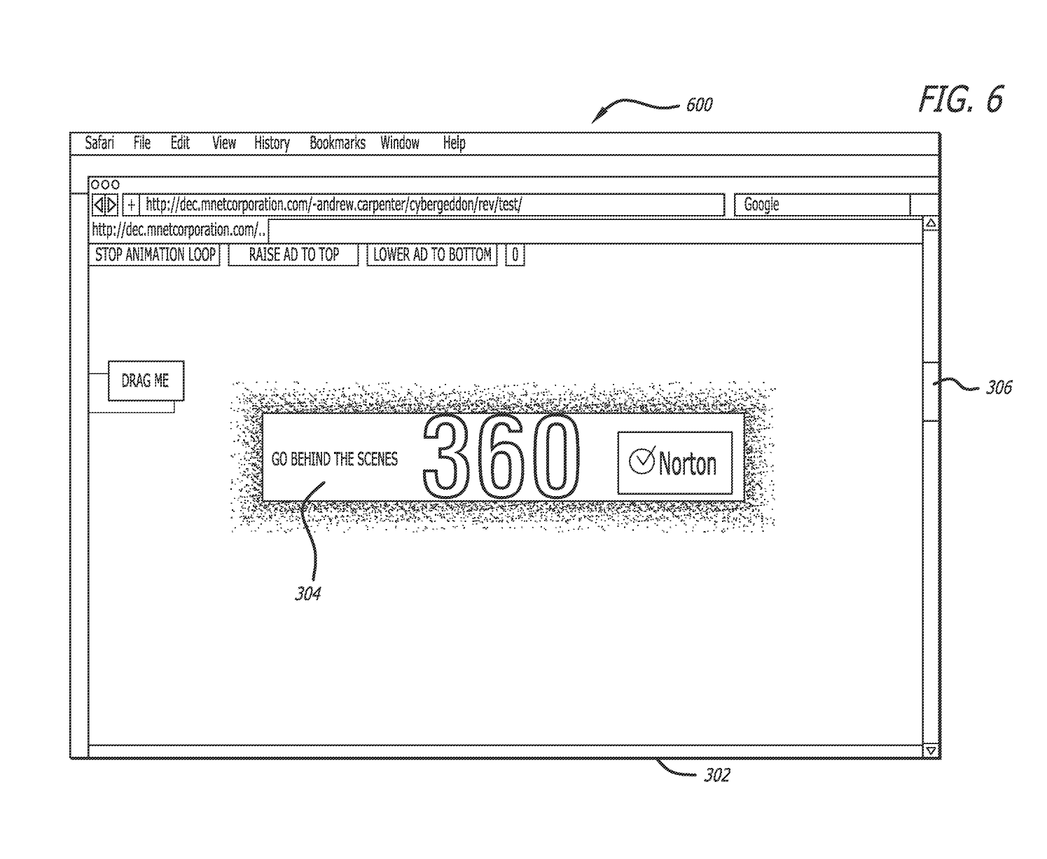

FIG. 6 is another illustration 600 showing the advertising unit 304 higher up in the webpage 302 and showing additional content with respect to the previous position illustrated in FIG. 5 as the user scrolls further down the webpage 302 as indicated by the lower position of the scrollbar 306. For example, FIG. 6 shows the words “Norton” being displayed in addition to “360” in the image within the advertising unit when compared to FIG. 5.

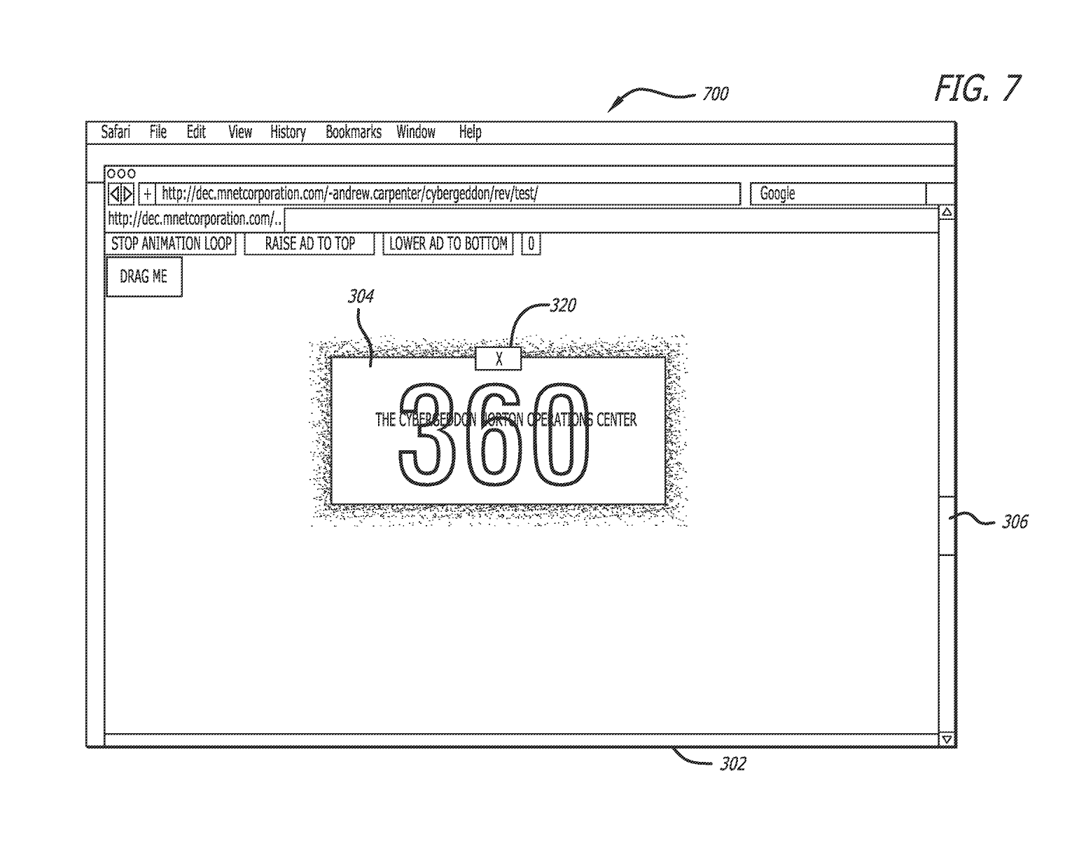

FIG. 7 is another illustration 700 showing the changes occurring in the advertising unit 304 as a result of its displacement from the initial position at the bottom of the webpage 302. When compared to FIG. 6, the user continues to scroll down towards the lower portion of the webpage 302 as indicated by the position of the scrollbar 306 and the advertising unit 304 has a significant change in size as it attains a prominent position at approximately the center of the display/webpage 302. Moreover, less content is displayed in 304 in the illustration 700 as compared to the advertising unit 304 in the illustration 600 of FIG. 6 in accordance with this embodiment. For example, the sponsor information “Norton” is no longer visible in the advertising unit 304 illustrated in FIG. 7. In an embodiment, the advertising unit 304 can be further provided with a button 320 that facilitates the user to close the unit 304.

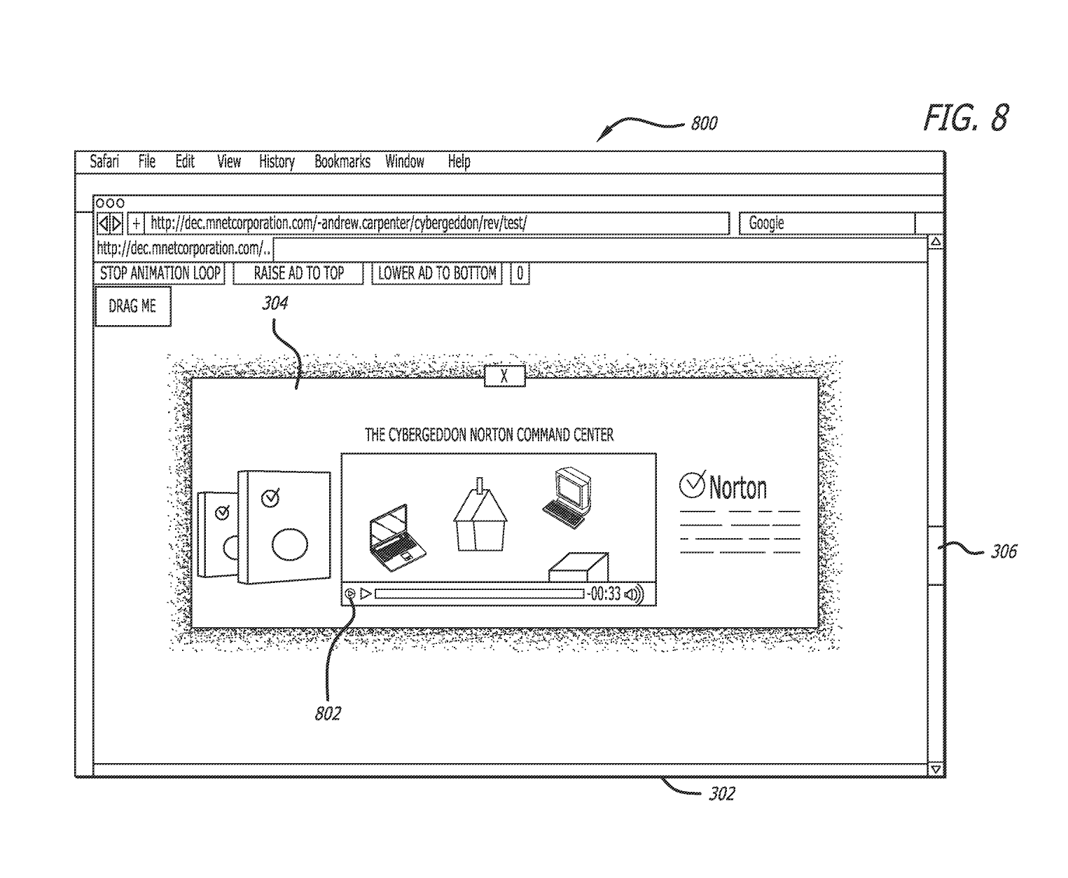

FIG. 8 is another illustration 800 showing the changes occurring in the advertising unit 304 as a result of its gradual displacement from the initial position at the bottom of the webpage 302 due to the user scrolling to the lower portion of the webpage 302 as indicated by the position of the scrollbar 306. When compared to FIG. 7, the advertising unit 304 does not have a noticeable change in position. However, the advertising unit 304 is larger and attains the maximum possible size for which it is configured and the content displayed in the advertising unit 304 of FIG. 8 is very different from the content displayed in FIG. 7. In an embodiment, the size of the advertising unit 304 is gradually increased as it attains prominence on the display as the increasing prominence is indicative of user interest in the advertising unit 304. This embodiment facilitates capitalizing further on the user interest thus generated by displaying ancillary content related to the advertiser upon the advertising unit 304 attaining the maximum possible size. The advertising unit 304 shows a video player with user controls so that users can play the video associated with the advertisement if they so desire by clicking the play button 802.

Thus, as can be seen in different embodiments described supra, by scrolling down the page the user's scroll causes the ad unit 304 to change in some embodiments giving the visual impression of a sliding “window” or view that appears to reveal hidden or additional content “behind” the page or other displayed content being viewed. It will be recognized by those of skill that the scrolling can be effectuated by moving a slide bar with a cursor, clicking page control arrows, sliding a finger on a touch screen display, or tilting or maneuvering a hand held device responsive to positional changes.

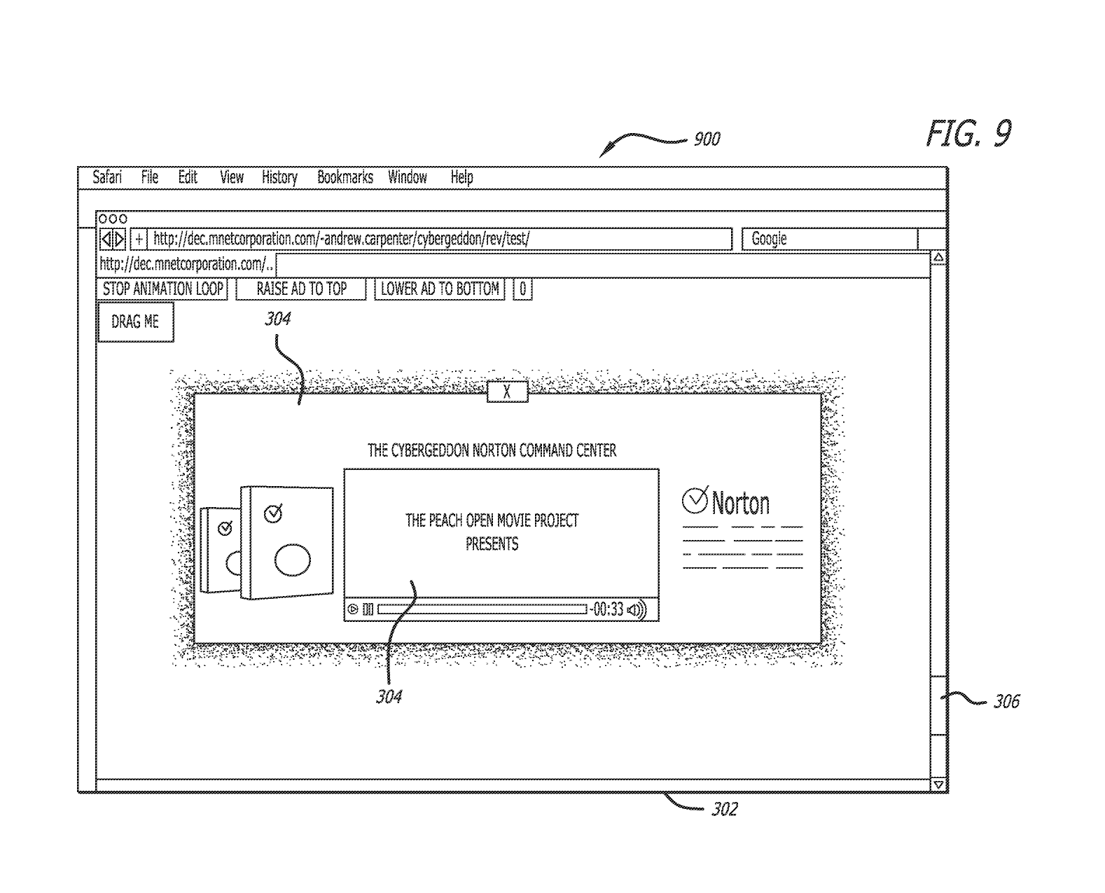

FIG. 9 is a schematic FIG. 900 wherein the advertising unit 304 plays a video associated with the advertiser upon the user clicking the play button or upon detection of some other interaction or positioning event that warrants or initiates playing of media with or via the ad unit. In an embodiment, the video can be played automatically upon the user continuing to scroll lower or if the advertising unit 304 remains at the current position within the webpage 302 for a predetermined time period.

Thus, as the advertising unit 304, gradually moves up the webpage and attains a prominent position within the display/webpage as seen in FIGS. 3-9, it can be concluded that the user watching the advertisement is interested in it and accordingly, the size and the content is varied to capture the user's attention. Moreover, the gradual increase in size also tends to be less intrusive as the advertisement gains prominence on the display only on tacit user approval. In an embodiment, the advertisement unit 304 will automatically disappear as the user scrolls down or up the page. In an embodiment, a mechanism such as a ‘close window’ link can be provided on the advertising unity 304 to facilitate its closure when the user is not interested in viewing the ad or if the user has completed viewing the ad and would like to continue browsing the webpage content below the advertisement unit or overlay.

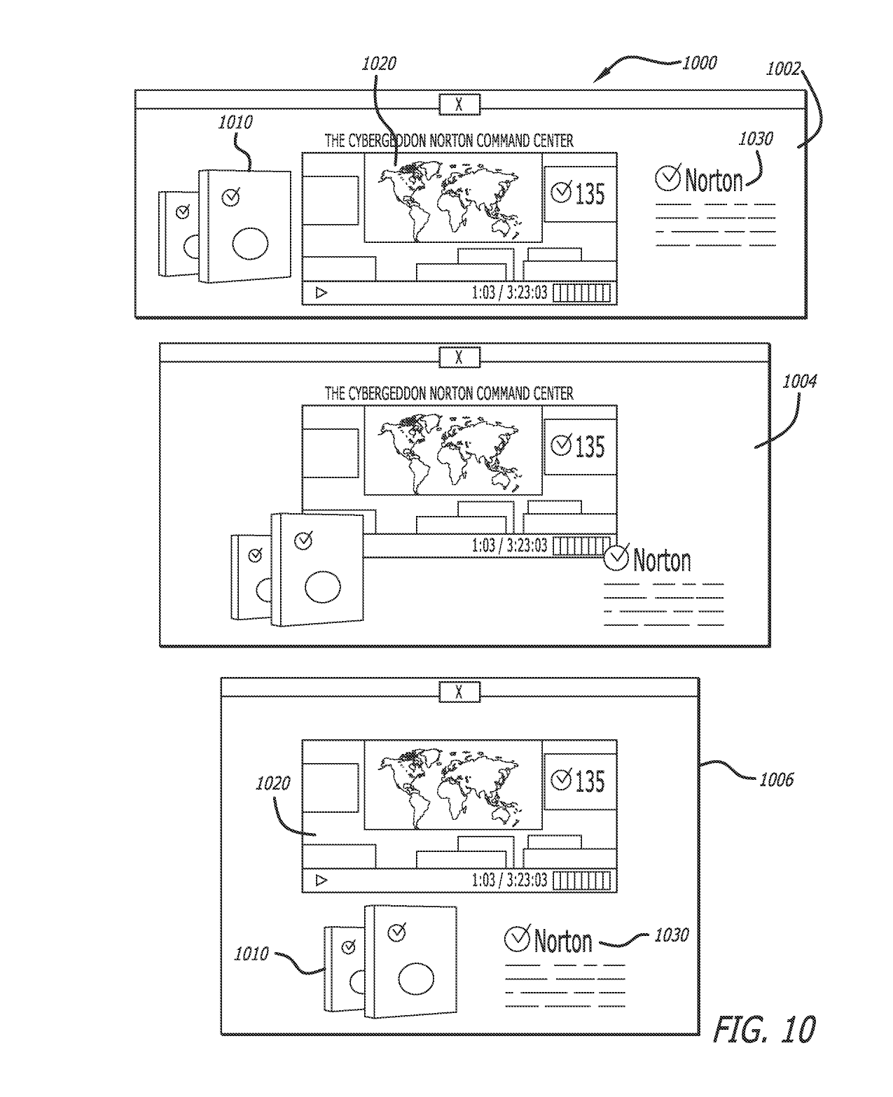

FIG. 10 is a schematic diagram 1000 showing an interactive reveal ad unit 304 responding to an input. As described supra, resizing a browser window can cause part of a display to be obscured so that the user is not able to view the complete display. In an embodiment the interactive reveal advertising unit responds to one or more of the browser width and resolution of the output device. Based on these factors, an initial layout is determined for the advertising unit or the overlay. In an embodiment, the content within the advertising unit shifts position or resizes to adapt to a display device's size shift. At 1002, the initial configuration or a default expanded view of an advertising unit or an overlay when a display device is in a landscape orientation is shown. The overlay at 1002 includes three prominent components, an image 1010, a video player 1020 and a text message 1030 arranged sequentially along the horizontal axis of the view. Subsequently, when a device displaying the advertising unit is being re-oriented, the layout of the components 1010, 1020 and 1030 begins to shift within the advertising unit as shown at 1004. It can be seen that the display device is being rotated to be oriented along a vertical axis at 1004 and the components 1010, 1020 and 1030 are automatically being rearranged to fit the view. At 1006, the re-orientation is complete and the final view upon the device attaining a portrait orientation is shown. As illustrated at 1006, the components 1010, 1020 and 1030 are automatically rearranged wherein the video player 1020 which was arranged second in the sequential order at 1002 and having the largest size is placed on the top while the first and third components, the image 1010 and the text message 1030 having a smaller size compared to the player 1020 are arranged below the player 1020 in an optimal arrangement that provides a compact yet complete view.

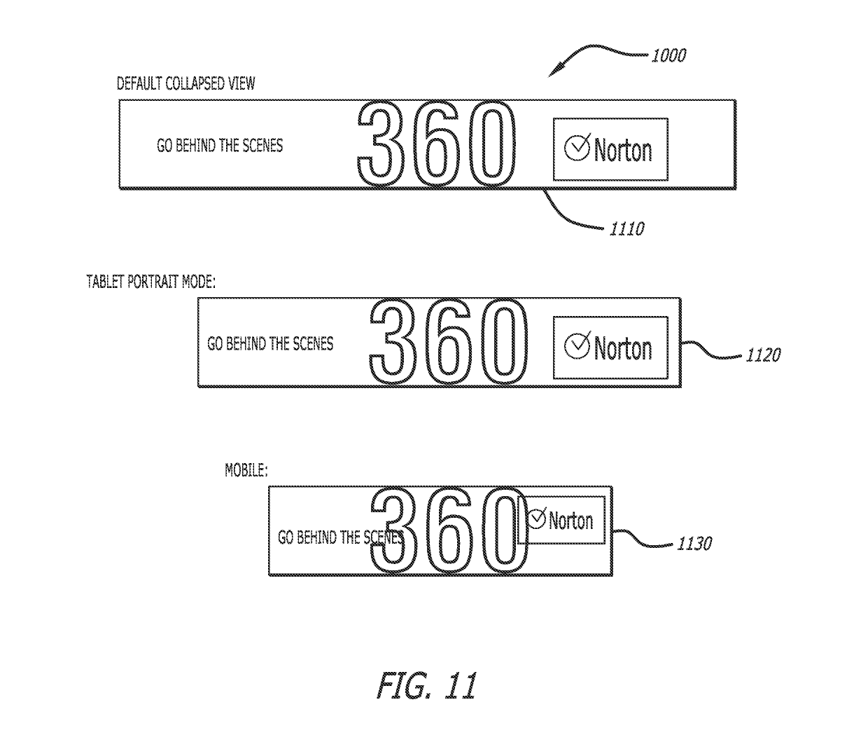

FIG. 11 is a schematic diagram illustrating an embodiment wherein the advertising unit or the overlay 304 is automatically adjusted to suit the width and resolution of an output device. At 1100, a default collapsed view of the advertising unit is shown. The configuration shown at 1100 that generally appears when a webpage comprising the advertising unit is initially loaded by a device in accordance with embodiments described herein. At 1120, a view of the advertising unit on the display of a tablet device is shown. The advertising unit shown at 1120 is at one of the intermediate positions during a user scroll in accordance with embodiments described supra is shown. At 1130, a view of the advertising unit on the display of a mobile communication device, such as a smart phone is shown. The advertising unit at 1130 is at one of the intermediate positions during a user scroll in accordance with embodiments described supra.

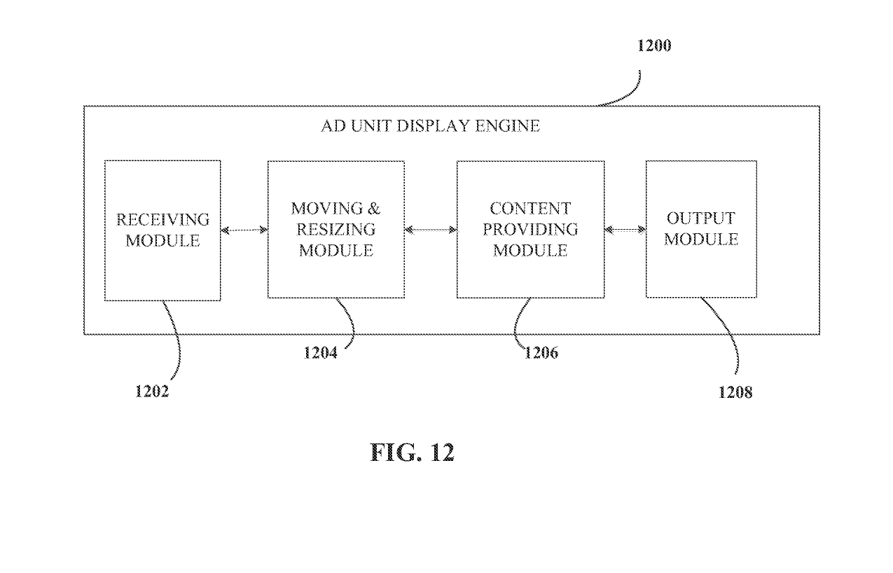

FIG. 12 is a block diagram depicting certain modules within an overlay or an ad unit display engine in accordance with aspects described herein. The ad unit display engine 1200 is operable to receive and display an overlay or an ad, the content or creative of which responds directly to user interaction thereby engaging the user and providing greater value to sponsors/advertisers. The ad unit display engine 1200 comprises a receiving module 1202 which is operable to initially receive an ad unit 304 comprised within a webpage 302 from one or more servers (not shown) in accordance with embodiments described herein. In addition, the receiving module 1202 is also configured to receive user interaction with the webpage 302 comprising the ad unit 304. For example, when the user scrolls or swipes the webpage 302 up or down, such user interaction is obtained by the receiving module 1202 which transmits such interactions to the moving and resizing module 1204.

The moving and resizing module 1204 moves and resizes the ad unit 304 based on the user interaction detected by the receiving module 1202. For example, the ad unit 304 can be initially displayed in a manner that does not intrude on a user's browsing experience and as the user moves the webpage 302 up or down, the ad unit can also scroll in the same or opposite direction of the webpage 302 based on the initial placement of the ad unit 304. Additionally, the size of the ad unit 304 can also be increased so as to capture the user's attention. In an embodiment, the moving and resizing module 1204 can be configured to vary the size of the ad unit 304 gradually with a corresponding gradual change in the position of the ad unit 304 relative to the webpage 302 in which it is comprised.

The moving and resizing module 1204 is further configured to work synchronously with the content providing module 1206 so that the creative within the ad unit 304 can be varied gradually as the ad unit 304 is resized while scrolling with the webpage. In an embodiment, a local cache memory can initially receive and cache the content to be unveiled gradually from the server initially along with the webpage. The content providing module 1206 can obtain the content to be displayed within the ad unit 304 from the local cache memory. The content providing module 1204 can comprise instructions regarding which of the cached content is to be provided at specific positions and sizes of the ad unit 304. The output module 1206 is configured to output the ad unit 304 and associated content to a display device.

In an embodiment, the receiving module 1202 is also configured to receive further input such as a change in the size of a window displaying the ad unit 304 or a change in the orientation of a device displaying the ad unit 304. The receiving module 1202 is configured to communicate such input to the moving and resizing module 1204 which can move the components of the creative within the ad unit 304 to suit the change in the size and/or orientation so that the user has a complete view of the creative. In this embodiment, it can be appreciated that as there is no change in the content within the overlay or in the creative presented within the ad unit 304. Therefore, the moving and resizing module 1204 can communicate the changes in the size and arrangements of the components within the ad unit 304 to the output module 1206 which changes the display outputted to the user accordingly.

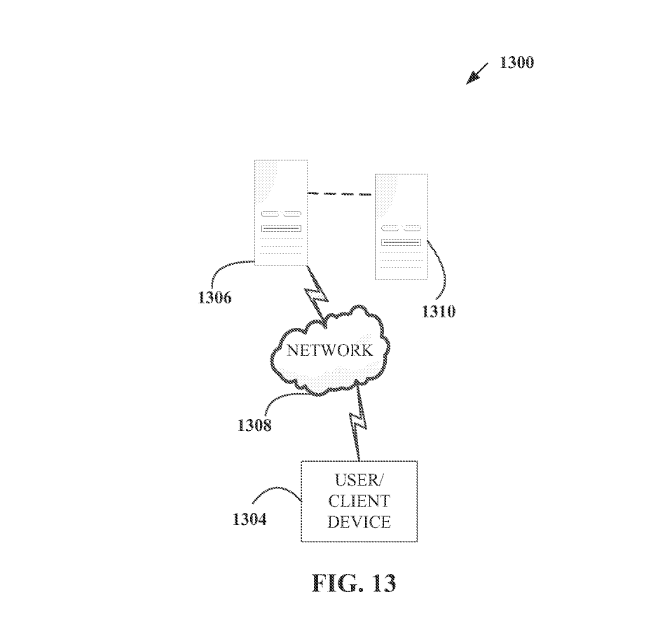

FIG. 13 shows an illustrative embodiment of a communication system 1300 comprising a plurality of computing devices configured to implement various aspects of the interactive ad unit 304 described herein. The communication system 1300 comprises a client/user device 1304 that initially transmits a request for a webpage to a server 1306 via a network 1308, such as, the Internet. The server 1306 retrieves the requested page for presentation to the user. In addition, the server 1306 also retrieves an advertisement to be served along with the webpage. Various methods can be employed to retrieved advertisements pertinent to a requested page. In an embodiment, the server 1306 can obtain the content for the advertisement from within its own resources. However, content for the advertisements served with webpages is usually supplied to the webservers by separate ad servers such as ad server 1310. An “ad server” comprises a server that stores online advertisements for presentation to users. “Ad serving” refers to methods used to place online advertisements on websites, in applications, or other places where users are more likely to see them, such as during an online session or during computing platform use, for example. Although the ad server 1310 is illustrated as maintaining a separate connection with the server 1306, it can be appreciated that the server 1306 and ad server 1310 can communicate via the network 1308. Upon retrieving the appropriate ad content from the ad server 1310, the server 1306 assembles the webpage 302 with the requested content and an interactive reveal ad unit 304 in accordance with embodiments described herein and transmits the webpage 302 with the ad unit 304 for display at the client device 1304. In an embodiment, the client device 1304 can include an ad unit display engine 1200 as described herein to display the ad 304 in an interactive manner based on the processor executable instructions received from the server 1306.

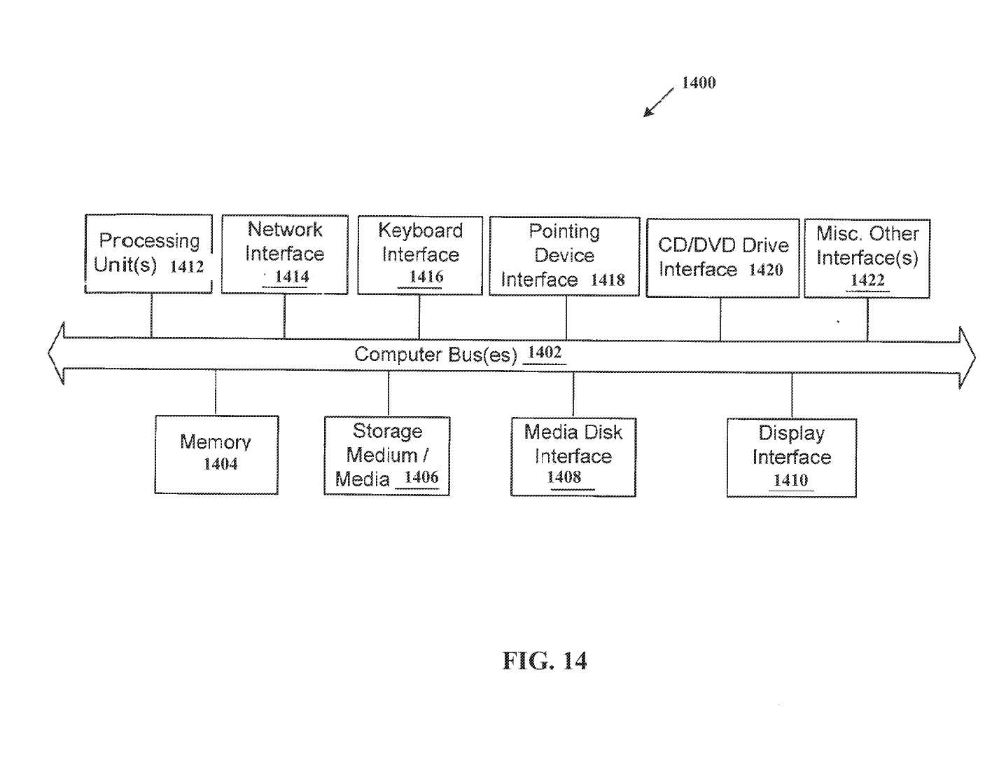

As shown in the example of FIG. 14, internal architecture of a computing device 1400 includes one or more processing units (also referred to herein as CPUs) 1412, which interface with at least one computer bus 1402. Also interfacing with computer bus 1402 are persistent storage medium/media 1406, network interface 1414, memory 1404, e.g., random access memory (RAM), run-time transient memory, read only memory (ROM), etc., media disk drive interface 1408, an interface 1420 for a drive that can read and/or write to media including removable media such as floppy, CD-ROM, DVD, etc., media, display interface 1410 as interface for a monitor or other display device, keyboard interface 1416 as interface for a keyboard, pointing device interface 1418 as an interface for a mouse or other pointing device, and miscellaneous other interfaces 1422 not shown individually, such as parallel and serial port interfaces, a universal serial bus (USB) interface, and the like.

Memory 1404 interfaces with computer bus 1402 so as to provide information stored in memory 1404 to CPU 1412 during execution of software programs such as an operating system, application programs, device drivers, and software modules that comprise program code or logic, and/or computer-executable process steps, incorporating functionality described herein, e.g., one or more of process flows described herein. CPU 1412 first loads computer-executable process steps, modules/sub-modules or logic from storage, e.g., memory 1404, storage medium/media 1406, removable media drive, and/or other storage device. CPU 1412 can then execute the stored process steps/logic. Stored data, e.g., data stored by a storage device, can be accessed by CPU 1412 during the execution of computer-executable process steps.

Persistent storage medium/media 1406 is a computer readable storage medium(s) that can be used to store software and data, e.g., an operating system and one or more application programs. Persistent storage medium/media 1406 can also be used to store device drivers, such as one or more of a digital camera driver, monitor driver, printer driver, scanner driver, or other device drivers, web pages, content files, metadata, playlists and other files. Persistent storage medium/media 1406 can further include program modules and data files used to implement one or more embodiments of the present disclosure.

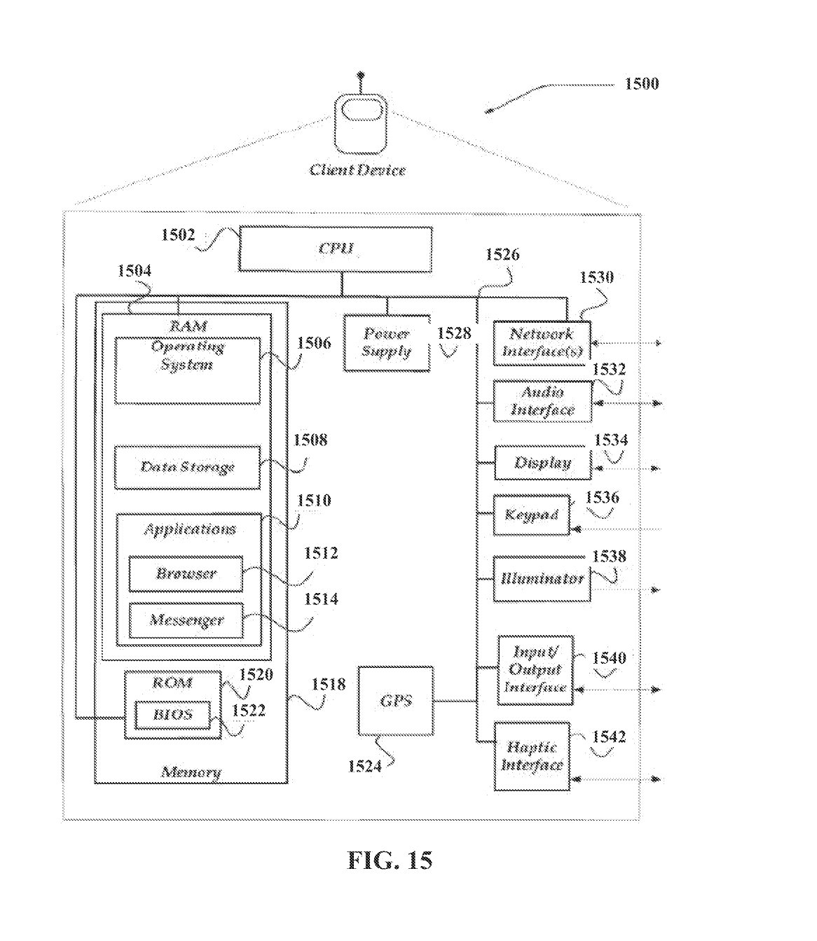

FIG. 15 is a schematic diagram illustrating a client device implementation of a computing device in accordance with embodiments of the present disclosure. A client device 1500 may include a computing device capable of sending or receiving signals, such as via a wired or a wireless network, and capable of running application software or “apps”. A client device may, for example, include a desktop computer or a portable device, such as a cellular telephone, a smart phone, a display pager, a radio frequency (RF) device, an infrared (IR) device, a Personal Digital Assistant (PDA), a handheld computer, a tablet computer, a laptop computer, a set top box, a wearable computer, an integrated device combining various features, such as features of the forgoing devices, or the like.

A client device may vary in terms of capabilities or features. The client device can include standard components such as a CPU 1502, power supply 1528, a memory 1518, ROM 1520, BIOS 1522, network interface(s) 1530, audio interface 1532, display 1534, keypad 1536, illuminator 1538, I/O interface 1540 interconnected via circuitry 1526. Claimed subject matter is intended to cover a wide range of potential variations. For example, the keypad 1536 of a cell phone may include a numeric keypad or a display 1534 of limited functionality, such as a monochrome liquid crystal display (LCD) for displaying text. In contrast, however, as another example, a web-enabled client device 1500 may include one or more physical or virtual keyboards 1536, mass storage, one or more accelerometers, one or more gyroscopes, global positioning system (GPS) 1524 or other location/position/orientation identifying capability, Haptic interface 1542, or a display with a high degree of functionality, such as a touch-sensitive color 2D or 3D display, for example. The memory 1518 can include Random Access Memory 1504 including an area for data storage 1508.

A client device may include or may execute a variety of operating systems 1506, including a personal computer operating system, such as a Windows, iOS or Linux, or a mobile operating system, such as iOS, Android, or Windows Mobile, or the like. A client device 1500 may include or may execute a variety of possible applications 1510, such as a client software application 1514 enabling communication with other devices, such as communicating one or more messages such as via email, short message service (SMS), or multimedia message service (MMS), including via a network, such as a social network, including, for example, Facebook, LinkedIn, Twitter, Flickr, or Google+, to provide only a few possible examples. A client device 1500 may also include or execute an application to communicate content, such as, for example, textual content, multimedia content, or the like. A client device 1500 may also include or execute an application 1512 to perform a variety of possible tasks, such as browsing, searching, playing various forms of content, including locally stored or streamed content, such as, video, or games (such as fantasy sports leagues). The foregoing is provided to illustrate that claimed subject matter is intended to include a wide range of possible features or capabilities.

For the purposes of this disclosure a computer readable medium stores computer data, which data can include computer program code that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

TABLE I below shows a non-limiting example of source code for generating the web page in accordance with an embodiment.

```
<html>
      <head>
          <meta name=“viewport” content=“width=device-width, minimum-scale=1.0,
maximum-scale=1.0, initial-scale=1.0, user-scalable=no”>
      <script type=“text/javascript” src=“script.js”></script>
      <link href=“style.css” rel=“stylesheet” type=“text/css” />
      <link href=‘http://fonts.googleapis.com/css?family=Francois+One’ rel=‘stylesheet’
type=‘text/css’>
      </head>
      <body onload=“prepare( );”>
          <!-- MAIN AD CODE -->
          <div id=“parallax-container”>
            <div id=“parallax-mask”>
                  <img id=“bg” src=“images/bg.jpg” />
                  <div id=“bg-expanded”></div>
                  <img id=“n3” src=“images/3.png” />
                  <img id=“n6” src=“images/6.png” />
                  <img id=“n0” src=“images/0.png” />
                  <div id=“behind”>
                        GO BEHIND THE SCENES
                  </div>
                  <div id=“video-container”>
                        <video id=“video” width=“500” height=“284” controls=“true”
poster=“videos/video.jpg” >
                              <source
src=“http://media.w3.org/2010/05/bunny/trailer.mp4” >
                              <source src=“videos/stuff_anthem_es.ogv” />
                        </video>
                  </div>
                  <img id=“boxes” src=“images/boxes.png” />
                  <div id=“norton-info”>
                        <img id=“logo” src=“images/logo.png” />
                        <div id=“slogan”>Working behind the scenes to<br />Protect the
Stuff that matters</div>
                        <a onclick=“openLink(‘#lounge’);” href=“#lounge”><div
id=“more”>MORE BEHIND THE SCENES AND<br />FREE PRODUCT TRIALS
&raquo;</div></a>
                  </div>
            </div>
            <div id=“parallax-shadow”></div>
            <div id=“overlay”>
                  <img id=“close” onclick=“collapse(event);” src=“images/close.png” />
                  <div id=“command”>THE CYBERGEDDON NORTON SECURITY
OPERATIONS CENTER</div>
            </div>
            <div id=“clicktarget” onclick=“expand(event);”></div>
          </div>
          <!-- MAIN AD CODE -->
      </body>
</html>
```

TABLE II below shows non limiting example code, such as, java script code, used to implement embodiments described herein.

```
window.getOffset = function(el) {
      var e = document.getElementById(el);
      var offset = {x:0,y:0};
      while (e)
      {
          offset.x += e.offsetLeft;
          offset.y += e.offsetTop;
          e = e.offsetParent;
      }
      if (document.documentElement && (document.documentElement.scrollTop ||
document.documentElement.scrollLeft))
      {
          offset.x −= document.documentElement.scrollLeft;
          offset.y −= document.documentElement.scrollTop;
      }
      else if (document.body && (document.body.scrollTop || document.body.scrollLeft))
      {
          offset.x −= document.body.scrollLeft;
          offset.y −= document.body.scrollTop;
      }
      else if (window.pageXOffset || window.pageYOffset)
      {
          offset.x −= window.pageXOffset;
          offset.y −= window.pageYOffset;
      }
      return offset;
}
window.prepare = function( ) {
      // start animation loop;
      window.bannerloop_id = setInterval(bannerloop,100);
      window.addEventListener(“resize”,positionNumbers,false);
      //preload images
      if (document.images) {
          preloader = new Image( );
          // set image url
          img = new Array( );
          img[0] = “images/boxes.png”;
          img[1] = “images/logo.png”;
          img[2] = “videos/video.jpg”;
          for(i=0; i<img.length; i++) {
            preloader.src = img[i];
          }
      }
      /* ADJUST AD UNIT SIZE & STYLES */
      /* IF THIS CAN BE APPLIED AS CSS, DYNAMIC RESIZING CODE IS NOT
REQUIRED */
      /*
          max-width: 974px;
          width: 100%;
          height: 120px;
          -webkit-transition: all 1.5s ease-in-out;
          -oz-transition: all 1.5s ease-in-out;
          -o-transition: all 1.5s ease-in-out;
          transition: all 1.5s ease-in-out;
          @media only screen and (min-width : 974px) {
            .expanded {
                  height: 420px !important;
            }
          }
          @media only screen and (max-width : 973px) {
            .expanded {
                  height: 650px !important;
            }
          }
      */
}
window.bannerloop = function( ) {
      if(!window.banner_expanded) {
          w = document.getElementById(“parallax-container”).clientWidth;
          offset = getOffset(“parallax-container”).y;
          offsetpercent = offset / window.innerHeight;
          // limit to lower half of screen
          if(offsetpercent < 0.5) offsetpercent = 0.5;
          if(offsetpercent > 0.9) offsetpercent = 0.9;
          // normalize & invert offset
          offsetpercent = 1 − ((offsetpercent−0.5)*2.5);
          // behind the scenes
          behind = document.getElementById(“behind”);
          offsetrange = (w/2)−110;
          if(offsetpercent > 0.05) {
            behind.style.width = “200px”;
          }
          else {
            behind.style.width = “0”;
          }
          if(offsetpercent > 0.2) {
            behind.style.left = 20 + (offsetrange * (1−((offsetpercent−0.2)*1.25))) + “px”;
          }
          else behind.style.left = 20 + offsetrange + “px”;
          // background (starting offset) − ((start|end ratio) * (final offset)
          document.getElementById(“bg”).style.top = ( −(w*0.123) − (offsetpercent *
w*0.185) )+“px”;
          // numbers
          n3 = document.getElementById(“n3”);
          offsetrange = (w/2)−70;
          n3.style.opacity = offsetpercent;
          n3.style.left = −160 + (offsetrange * offsetpercent) + “px”;
          n6 = document.getElementById(“n6”);
          n6.style.left = (w/2)−80; + “px”;
          n6.style.opacity = offsetpercent;
          n0 = document.getElementById(“n0”);
          offsetrange = (w/2)−80;
          n0.style.opacity = offsetpercent;
          n0.style.left = (w/2) + 80 + (offsetrange * (1−offsetpercent)) + “px”;
      }
}
window.positionNumbers = function( ) {
      if(window.banner_expanded) {
          w = document.getElementById(“parallax-container”).clientWidth;
          n3 = document.getElementById(“n3”);
          n6 = document.getElementById(“n6”);
          n0 = document.getElementById(“n0”);
          n3.style.webkitTransition = “all 1.5s ease-in-out”;
          n3.style.MozTransition = “all 1.5s ease-in-out”;
          n3.style.OTransition = “all 1.5s ease-in-out”;
          n3.style.transition = “all 1.5s ease-in-out”;
          n6.style.webkitTransition = “all 1.5s ease-in-out”;
          n6.style.MozTransition = “all 1.5s ease-in-out”;
          n6.style.OTransition = “all 1.5s ease-in-out”;
          n6.style.transition = “all 1.5s ease-in-out”;
          n0.style.webkitTransition = “all 1.5s ease-in-out”;
          n0.style.MozTransition = “all 1.5s ease-in-out”;
          n0.style.OTransition = “all 1.5s ease-in-out”;
          n0.style.transition = “all 1.5s ease-in-out”;
          n3.style.height = “345px”;
          n3.style.opacity = 0.1;
          n3.style.left = (w/2)−380; + “px”;
          n6.style.height = “345px”;
          n6.style.opacity = 0.1;
          n6.style.left = (w/2)−130; + “px”;
          n0.style.height = “345px”;
          n0.style.opacity = 0.1;
          n0.style.left = (w/2)+130; + “px”;
      }
}
window.expand = function(e) {
console.log(“expand”);
      if(!window.banner_expanded) {
          /* EXPAND TRACKING GOES HERE */
          parallax = document.getElementById(“parallax-container”);
          bg = document.getElementById(“bg”);
          bg_expanded = document.getElementById(“bg-expanded”);
          window.banner_expanded = true;
          parallax.className = “expanded”;
          bg_expanded.className = “expanded”;
          document.getElementById(“clicktarget”).style.display = “none”;
          document.getElementById(“parallax-mask”).style.top = “20px”;
          bg.style.webkitTransition = “top 1.5s ease-in-out”;
          bg.style.MozTransition = “top 1.5s ease-in-out”;
          bg.style.OTransition = “top 1.5s ease-in-out”;
          bg.style.transition = “top 1.5s ease-in-out”;
          window.lastbg = bg.style.top;
          bg.style.top = −(w*0.123)+“px”;
          positionNumbers( );
          document.getElementById(“bg-expanded”).style.opacity = 1;
          document.getElementById(“overlay”).style.opacity = 1;
          document.getElementById(“behind”).style.opacity = 0;
          setTimeout(reveal,1500);
      }
}
window.collapse = function(e) {
console.log(“collapse”);
      if(window.banner_expanded) {
          /* COLLAPSE TRACKING GOES HERE */
          parallax = document.getElementById(“parallax-container”);
          w = parallax.clientWidth;
          bg = document.getElementById(“bg”);
          bg_expanded = document.getElementById(“bg-expanded”);
          n3 = document.getElementById(“n3”);
          n6 = document.getElementById(“n6”);
          n0 = document.getElementById(“n0”);
          window.banner_expanded = false;
          parallax.removeAttribute(“class”);
          bg_expanded.removeAttribute(“class”);
          document.getElementById(“clicktarget”).style.display = “block”;
          document.getElementById(“parallax-mask”).style.top = “0px”;
          bg.style.top = window.lastbg ? window.lastbg : −(w*0.123)−(w*0.185)+“px”;
          n3 = document.getElementById(“n3”);
          n6 = document.getElementById(“n6”);
          n0 = document.getElementById(“n0”);
          n3.style.height = “210px”;
          n3.style.opacity = 1;
          n6.style.height = “210px”;
          n6.style.opacity = 1;
          n6.style.left = (w/2)−80; + “px”;
          n0.style.height = “210px”;
          n0.style.opacity = 1;
          document.getElementById(“bg-expanded”).style.opacity = 0;
          document.getElementById(“overlay”).style.opacity = 0;
          document.getElementById(“behind”).style.opacity = 1;
          document.getElementById(“video-container”).style.opacity = 0;
          document.getElementById(“video”).pause( );
          boxes = document.getElementById(“boxes”);
          boxes.style.opacity = 0;
          boxes.style.webkitTransform = “scale(0.1)”;
          boxes.style.MozTransform = “scale(0.1)”;
          boxes.style.OTransform = “scale(0.1)”;
          boxes.style.transform = “scale(0.1)”;
          norton = document.getElementById(“norton-info”);
          norton.style.opacity = 0;
          norton.style.webkitTransform = “scale(0.1)”;
          norton.style.MozTransform = “scale(0.1)”;
          norton.style.OTransform = “scale(0.1)”;
          norton.style.transform = “scale(0.1)”;
          setTimeout(resetTransitions,100);
      }
}
window.reveal = function( ) {
      if(window.banner_expanded) {
          document.getElementById(“video-container”).style.opacity = 1;
          boxes = document.getElementById(“boxes”);
          boxes.style.webkitTransform = “scale(1)”;
          boxes.style.MozTransform = “scale(1)”;
          boxes.style.OTransform = “scale(1)”;
          boxes.style.transform = “scale(1)”;
          boxes.style.opacity = 1;
          norton = document.getElementById(“norton-info”);
          norton.style.webkitTransform = “scale(1)”;
          norton.style.MozTransform = “scale(1)”;
          norton.style.OTransform = “scale(1)”;
          norton.style.transform = “scale(1)”;
          norton.style.opacity = 1;
      }
}
window.resetTransitions = function( ) {
      bg = document.getElementById(“bg”);
      bg.style.webkitTransition = “top 0.5s ease-out”;
      bg.style.MozTransition = “top 0.5s ease-out”;
      bg.style.OTransition = “top 0.5s ease-out”;
      bg.style.transition = “top 0.5s ease-out”;
      n3.style.webkitTransition = “all 0.5s ease-out”;
      n3.style.MozTransition = “all 0.5s ease-out”;
      n3.style.OTransition = “all 0.5s ease-out”;
      n3.style.transition = “all 0.5s ease-out”;
      n6.style.webkitTransition = “all 0.5s ease-out”;
      n6.style.MozTransition = “all 0.5s ease-out”;
      n6.style.OTransition = “all 0.5s ease-out”;
      n6.style.transition = “all 0.5s ease-out”;
      n0.style.webkitTransition = “all 0.5s ease-out”;
      n0.style.MozTransition = “all 0.5s ease-out”;
      n0.style.OTransition = “all 0.5s ease-out”;
      n0.style.transition = “all 0.5s ease-out”;
}
window.stopAnimation = function( ) {
      document.getElementById(“video”).pause( );
      clearInterval(window.bannerloop_id);
}
window.openLink = function(url) {
      if(url) {
          /* LINK TRACKING GOES HERE */
          location.hash = url;
      }
}
```

TABLE III below shows non-limiting example code used to implement embodiments described herein.

```
body, html {
      margin: 0; padding: 0;
}
body {
      font-family: ‘Francois One’, sans-serif;
      background: black;
      color: white;
}
#parallax-container {
      position: relative;
      margin: 0 auto;
      max-width: 974px;
      width: 100%;
      height: 120px;
      overflow: hidden;
      -webkit-transition: all 1.5s ease-in-out;
      -moz-transition: all 1.5s ease-in-out;
      -o-transition: all 1.5s ease-in-out;
      transition: all 1.5s ease-in-out;
}
#parallax-container a {
      text-decoration: none;
}
#parallax-mask {
      width: 100%;
      height: 100%;
      position: relative;
      overflow: hidden;
      -webkit-transition: all 1.5s ease-in-out;
      -moz-transition: all 1.5s ease-in-out;
      -o-transition: all 1.5s ease-in-out;
      transition: all 1.5s ease-in-out;
}
#parallax-shadow {
      position: absolute;
      z-index: 15;
      width: 100%;
      height: 100%;
      top: 0;
      left: 0;
      -webkit-box-shadow: inset 0 0 20px 5px black;
      -moz-box-shadow: inset 0 0 20px 5px black;
      -o-box-shadow: inset 0 0 20px 5px black;
      box-shadow: inset 0 0 20px 5px black;
}
#bg {
      width: 100%;
      position: absolute;
      top: −120px;
      left: 0;
      -webkit-transition: top 0.5s ease-out;
      -moz-transition: top 0.5s ease-out;
      -o-transition: top 0.5s ease-out;
      transition: top 0.5s ease-out;
      z-index: 1;
}
#bg-expanded {
      width: 100%;
      height: 420px;
      position: absolute;
      top: 0px;
      left: 0px;
      opacity: 0;
      -webkit-transition: all 1.5s ease-in-out;
      -moz-transition: all 1.5s ease-in-out;
      -o-transition: all 1.5s ease-in-out;
      transition: all 1.5s ease-in-out;
      z-index: 5;
      background: url(images/bg_expanded.jpg) no-repeat top center
      black;
      background-size: 1230px 100%;
}
#n3, #n6, #n0 {
      position: absolute;
      top: −40px;
      opacity: 0;
      -webkit-transition: all 0.5s ease-out;
      -moz-transition: all 0.5s ease-out;
      -o-transition: all 0.5s ease-out;
      transition: all 0.5s ease-out;
      z-index: 10;
      height: 210px;
}
#n3 {
      left: −160px;
}
#n6 {
      left: 407px;
}
#n0 {
      right: −160px;
}
#behind {
      position: absolute;
      z-index: 20;
      color: #cccccc;
      font-size: 20px;
      top: 45px;
      left: 390px;
      overflow: hidden;
      white-space: nowrap;
      width: 0;
      height: 30px;
      -webkit-transition: all 0.5s ease-out;
      -moz-transition: all 0.5s ease-out;
      -o-transition: all 0.5s ease-out;
      transition: all 0.5s ease-out;
}
#video-container {
      position: absolute;
      top: 90px;
      left: 0;
      width: 100%;
      z-index: 50;
      text-align: center;
      -webkit-transition: opacity 0.5s ease-in-out;
      -moz-transition: opacity 0.5s ease-in-out;
      -o-transition: opacity 0.5s ease-in-out;
      transition: opacity 0.5s ease-in-out;
      opacity: 0;
}
#video {
      margin: 0 auto;
}
#boxes {
      position: absolute;
      -webkit-transition: all 0.5s ease-in-out;
      -moz-transition: all 0.5s ease-in-out;
      -o-transition: all 0.5s ease-in-out;
      transition: all 0.5s ease-in-out;
      z-index: 60;
      opacity: 0;
      -webkit-transform: scale(0.1);
      -moz-transform: scale(0.1);
      -o-transform: scale(0.1);
      transform: scale(0.1);
}
#norton-info {
      position: absolute;
      -webkit-transition: all 0.5s ease-in-out;
      -moz-transition: all 0.5s ease-in-out;
      -o-transition: all 0.5s ease-in-out;
      transition: all 0.5s ease-in-out;
      z-index: 70;
      opacity: 0;
      -webkit-transform: scale(0.1);
      -moz-transform: scale(0.1);
      -o-transform: scale(0.1);
      transform: scale(0.1);
}
#slogan {
      font-size: 13px;
      margin: 30px 0 10px;
      text-shadow: 4px 4px 10px black;
}
#more {
      font-size: 13px;
      color: #d39b30;
      padding: 0.25em 0;
      text-shadow: 4px 4px 10px black;
}
#overlay {
      position: absolute;
      left: 0;
      top:0;
      width: 100%;
      text-align: center;
      z-index: 900;
      opacity: 0;
      -webkit-transition: opacity 1.5s ease-in-out;
      -moz-transition: opacity 1.5s ease-in-out;
      -o-transition: opacity 1.5s ease-in-out;
      transition: opacity 1.5s ease-in-out;
}
#command {
      position: absolute;
      width: 100%;
      left: 0;
      top: 75px;
      text-align:center;
}
#close {
      cursor:pointer;
}
#clicktarget {
      position: absolute;
      top: 0;
      left: 0;
      z-index:999;
      width: 100%;
      height: 120px;
      cursor:pointer;
}
@media only screen and (min-width : 974px) {
      .expanded {
          height: 420px !important;
      }
      #boxes {
          top: 130px;
          left: 5px;
      }
      #norton-info {
          top: 150px;
          right: 40px;
      }
}
@media only screen and (max-width : 973px) {
      .expanded {
          height: 650px !important;
      }
      #boxes {
          top: 400px;
          left: 150px;
      }
      #norton-info {
          top: 410px;
          right: 140px;
      }
      #more, #trial {
      padding: 0.5em 0;
      }
}
```

For the purposes of this disclosure a system or module is a software, hardware, or firmware (or combinations thereof), process or functionality, or component thereof, that performs or facilitates the processes, features, and/or functions described herein (with or without human interaction or augmentation). A module can include sub-modules. Software components of a module may be stored on a computer readable medium. Modules may be integral to one or more servers, or be loaded and executed by one or more servers. One or more modules may be grouped into an engine or an application.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client or server or both. In this regard, any number of the features of the different embodiments described herein may be combined into single or multiple embodiments, and alternate embodiments having fewer than, or more than, all of the features described herein are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

While the system and method have been described in terms of one or more embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

What is claimed is:

1. A method, comprising:
displaying, on a display of a computing device, a webpage comprising an advertising unit;
receiving, at the device, information representing user interaction with one of the webpage, the advertising unit or the device; and
effecting gradually, by the device, visible changes to content and size of the advertising unit based on the user interaction such that an amount of the content displayed and the size of the advertising unit depends on a position of the advertising unit relative to the webpage;
determining, by the device, if the advertising unit has attained a maximum possible size; and
displaying, by the device, further interactive content in the advertising unit upon the determination that the advertising unit has attained the maximum possible size.

2. The method of claim 1, wherein the device effectuates a scroll of the webpage based on the user interaction information.

3. The method of claim 2, wherein the visible changes comprise increasing the size of the advertising unit and the amount of the content as the scroll occurs along a first direction.

4. The method of claim 3, increasing the amount of content comprises displaying additional content gradually such that an amount of the additional content displayed in the advertising unit depends on the size and on the position of the advertising unit relative to the webpage.

5. The method of claim 3, wherein the visible changes comprise decreasing the size of the advertising unit and removing the additional content when the scroll occurs along a second direction that is opposite to the first direction.

6. The method of claim 1, wherein further comprising:
re-arranging, by the device, the content in the advertising unit upon the user interaction information indicating a change in an orientation of the computing device in the three-dimensional space.

7. The method of claim 1, wherein further comprising:
re-arranging, by the device, the content in the advertising unit based on a changed in the size of the display.

8. The method of claim 1, the interactive content is displayed upon receiving further user input.

9. The method of claim 8, the interactive content is video content and the further user input comprises a click on a video player displayed in the advertising unit.

10. A computing device comprising:
a processor;
a storage medium for tangibly storing thereon program logic for execution by the processor, the program logic comprising:
display logic, executed by the processor, for displaying a webpage comprising an advertising unit on a display of the computing device;
user interaction receiving logic, executed by the processor, for receiving information representing user interaction with one of the webpage, the advertising unit or the device;
effecting logic, executed by the processor, for effecting gradual visible changes to content and size of the advertising unit based on the user interaction such that an amount of the content displayed and the size of the advertising unit depends on a position of the advertising unit relative to the webpage;
size determining logic, executed by the processor, for determining if the advertising unit has attained a maximum possible size; and
display logic, executed by the processor, for displaying further interactive content in the advertising unit upon the determination that the advertising unit has attained the maximum possible size.

11. The device of claim 10 further comprising:
scrolling logic, executed by the processor, for scrolling the webpage based on the user interaction information.

12. The device of claim 11, wherein the effecting logic further comprises, size increasing logic that increases the size of the advertising unit as the scroll occurs along a first direction.

13. The device of claim 12, wherein the effecting logic further comprises, size decreasing logic that decreases the size of the advertising unit as the scroll occurs along a second direction that is opposite to the first direction.

14. The device of claim 13, wherein the effecting logic further comprises additional content display logic such that the amount of additional content displayed in the advertising unit is increased when the advertising unit moves in the first direction and the amount of additional content displayed in the advertising unit is decreased when the advertising unit moves in the second direction.

15. The device of claim 11, further comprising content rearranging logic, executed by the processor, for rearranging the content in the advertising unit upon the user interaction information indicating a change in an orientation of the computing device in the three-dimensional space.

16. The device of claim 11, the interactive content is video content and the further user input comprises a click on a video player displayed in the advertising unit.

17. A computer readable storage medium, comprising instructions, which when executed by a processor cause the processor to:
display, on a display of a computing device, a webpage comprising an advertising unit;
receive, at the device, information representing user interaction with one of the webpage, the advertising unit or the device;
effect visible changes to content and size of the advertising unit gradually based on the user interaction such that an amount of the content displayed and the size of the advertising unit depends on a position of the advertising unit relative to the webpage;
determine if the advertising unit has attained a maximum possible size; and
display further interactive content in the advertising unit upon the determination that the advertising unit has attained the maximum possible size.

18. The computer readable medium of claim 17, further comprising instructions for effectuating a scroll of the webpage based on the user interaction information.

19. The computer readable medium of claim 18, wherein the instructions for effecting visible changes further comprise instructions for increasing the size of the advertising unit and gradually displaying additional content as the scroll occurs along a first direction.

20. The computer readable medium of claim 19, wherein the instructions for effecting visible changes further comprise instructions for decreasing the size of the advertising unit and removing the additional content when the scroll occurs along a second direction that is opposite to the first direction.
